(19) United States
(12) Patent Application Publication
(10) Pub. No.: US 2017/0047082 A1
(43) Pub. Date: Feb. 16, 2017

(54) ELECTRONIC DEVICE AND OPERATION METHOD THEREOF

(71) Applicant: Samsung Electronics Co., Ltd., Gyeonggi-do (KR)

(72) Inventors: Min-Hee LEE, Seoul (KR); Sungmin KIM, Seoul (KR); Hangyul KIM, Seoul (KR); Yunjae LEE, Seoul (KR); Taemin CHO, Gyeonggi-do (KR)

(21) Appl. No.: 15/233,523

(22) Filed: Aug. 10, 2016

(30) Foreign Application Priority Data
Aug. 10, 2015 (KR) 10-2015-0112638

(51) Int. Cl. G10L 21/055; G10H 1/00; G10L 21/043

(52) U.S. Cl. CPC G10L 21/055; G10L 21/043; G10H 1/0008; G10H 2210/076; G10H 2220/096; G10H 2240/325

(57) ABSTRACT

Disclosed is an electronic device, which can acoustically or visually synchronize a plurality of independent beats and output the synchronized beats (or tempos) when executing a music application, including a user interface, a memory, and one or more processors electrically connected to the user interface and the memory, which display tempo progress information of music in response to playing of the music, detect an event while the music is played, synchronize the played music and tempo progress information of music according to the event, and output the synchronized music and tempo progress information.

### PRIORITY

This application claims priority under 35 U.S.C. §119(a) to Korean Application Serial No. 10-2015-0112638, which was filed in the Korean Intellectual Property Office on Aug. 10, 2015, the contents of which are incorporated herein by reference.

### BACKGROUND

1. Field of the Disclosure

The present disclosure relates generally to an electronic device, and more particularly, to an electronic device which can acoustically or visually synchronize a plurality of independent beats (or tempos) and output the synchronized beats (or tempos) when executing a music application, and a method thereof.

2. Description of the Related Art

Recently, the needs of a user to directly participate in music as well as simply listening to (for example, hearing) music have increased. For example, the user has a need to compose music or record music while directly playing the music. In order to meet such a trend, a recent electronic device provides various functions capable of playing a virtual musical instrument (for example, keyboard, drum, guitar, or the like) through various music applications, composing music, or editing music. The user may record music while more easily playing the music through the electronic device anywhere and at any time, and edit various music to compose and listen to new music.

Accordingly, research on a more intuitive technology for improving convenience based on a music application has been actively performed in the electronic device. For example, the music application provides audio data and a visual effect that match a tempo (for example, speed or beats per minute (BPM)) through a metronome function, and supports playing of different types of music or musical instruments.

When different types of music are provided, a music application plays the different types of music at independent tempos based on time (or meter) of elements. Accordingly, beats tend to become off-tempo in a performance by a plurality of elements of the conventional music application. Further, a metronome function provided by the conventional music application displays only a progress of tempo (e.g., speed, beats per minute (BPM)) of one among a plurality of music (e.g., musical instrument) having an independent time (or meter) or a progress of tempo of an entire piece of music. Accordingly, when components (such as speed, BPM, time) representing the tempo between the elements become off-tempo, the metronome function is inaccurate compared to actual playing and the user has difficulty in recognizing the tempo of each piece of music.

As such, there is a need in the art for a method and apparatus that maintain the proper tempo of the music.

### SUMMARY

The present disclosure has been made to address at least the above-mentioned problems and/or disadvantages and to provide at least the advantages described below.

Accordingly, an aspect of the present disclosure is to provide an electronic device, which eliminates confusion of beats when two or more elements having beat information coexist, and an operation method thereof.

Another aspect of the present disclosure is to provide an electronic device, which can simultaneously display tempo progress information of a plurality of elements having independent tempos in the music application, and an operation method thereof.

Another aspect of the present disclosure is to provide an electronic device, which can simultaneously output a plurality of elements in time with each other without becoming off-beat by synchronizing beats of the elements when expressing tempos of the elements, and an operation method thereof.

Another aspect of the present disclosure is to provide an electronic device, which can synchronize and provide a plurality of visual or acoustic outputs expressing tempos in the music application without becoming off-beat, and a method thereof.

In accordance with an aspect of the present disclosure, an electronic device includes a user interface, a memory, and one or more processors electrically connected to the user interface and the memory, wherein the one or more processors display tempo progress information of music in response to playing of the music, detect an event while the music is being played, synchronize the played music and tempo progress information of the music according to the event, and output the synchronized music and tempo progress information.

In accordance with another aspect of the present disclosure, a method of operating an electronic device includes playing music and displaying tempo progress information of the music based on a user interface, detecting an event while the music is played, and synchronizing the played music and tempo progress information of music according to the event and outputting the synchronized music and tempo progress information.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 schematically illustrates a configuration of an electronic device according to embodiments of the present disclosure;

FIGS. 2 and 3 illustrate examples of a user interface of a music application according to embodiments of the present disclosure;

FIGS. 4, 5 and 6 illustrate examples of playing a sound sample in the electronic device according to embodiments of the present disclosure;

FIG. 7 illustrates an operation method of the electronic device according to embodiments of the present disclosure;

FIG. 8 illustrates a method of operating a music application in the electronic device according to embodiments of the present disclosure;

FIGS. 9 and 10 illustrate examples for describing synchronizing tempos of different elements in the electronic device according to embodiments of the present disclosure;

FIGS. 11 and 12 illustrate other examples for describing synchronizing tempos of different elements in the electronic device according to embodiments of the present disclosure; and

FIGS. 13, 14, and 15 illustrate other examples for describing synchronizing tempos of different elements in the electronic device according to embodiments of the present disclosure.

### DETAILED DESCRIPTION OF EMBODIMENTS OF THE DISCLOSURE

Hereinafter, embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. Embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

Embodiments of the present disclosure relate to an electronic device for providing functions of performance, composition, arrangement, recording, and reproduction through a music application, and an operation method thereof. When an event (for example, simultaneous playing of another music, recording, or effect setting) operating based on a tempo is generated while music is played using a music application in the electronic device, tempos of a plurality of elements (for example, music) having independent tempos (or times, meters) may be all synchronized. When a plurality of elements coexist according to generation of an event while a particular element is played, processing of a plurality of independent beats according to the elements without becoming off-beat between the elements is disclosed. When a plurality of musical elements operating based on tempos coexist, synchronization to enable the elements have the same tempo is disclosed. According to embodiments, tempo progress information of the elements is simultaneously generated through acoustical and visual methods, and a plurality of beats are simultaneously generated without becoming off-beat.

In the following description, the music application includes a mobile digital audio workstation (DAW) application, and an application for independently or simultaneously playing a first music (for example, project), in which a performance or an effect by at least one virtual musical instrument is configured as one package, and a second music (for example, sound sample) that repeats a melody or a beat in the same music pattern.

According to an embodiment of the present disclosure, the electronic device includes all devices using one or more of all information and communication devices, a multimedia device, and a wearable device that support functions (for example, functions for performing various operations related to music based on the music application) according to embodiments of the present disclosure, and various processors such as an application device thereof, including an application processor (AP), a graphic processing unit (GPU), and a central processing unit (CPU).

For example, the electronic device includes at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device such as smart glasses, a head-mounted-device (HMD, or a smart watch.

The electronic device may further include a smart home appliance. The home appliance includes at least one of, for example, a television, a digital video disk (DVD) player, a refrigerator, an air conditioner, a vacuum cleaner, a washing machine, a set-top box, a home automation control panel, a TV box (e.g., Samsung HomeSync™, Apple TV™, or Google TV™), a game console (e.g., Xbox™ and PlayStation™), an electronic photo frame, at least one of a navigation device and an Internet of things (IoT) device.

The electronic device according to embodiments of the present disclosure may be a combination of one or more of the aforementioned various devices and may be a flexible device. The electronic device according to an embodiment of the present disclosure is not limited to the aforementioned devices, and may include a new electronic device according to the development of new technology.

The term “user” as used in embodiments of the present disclosure may refer to a person who uses an electronic device or an artificial intelligence electronic device that uses an electronic device. In embodiments of the present disclosure, a module or programming module includes at least one of various elements of the present disclosure, exclude some of the elements, or may further include other additional elements. The operations performed by the modules, programming module, or other elements according to embodiments of the present disclosure may be executed in a sequential, parallel, repetitive, or heuristic manner. Furthermore, some operations may be executed in a different order or may be omitted, or other operations may be added.

Hereinafter, a user interface, a method, and an apparatus for visualizing musical attributes of elements in the music application according to an embodiment of the present disclosure will be described with reference to the accompanying drawings. However, since the embodiments are not restricted or limited by the following description, it should be noted that applications can be made to the embodiments based on embodiments that will be described below. Hereinafter, embodiments of the present disclosure will be described based on an approach of hardware. However, embodiments of the present disclosure include a technology that uses both hardware and software and thus, the embodiments of the present disclosure may not exclude the perspective of software.

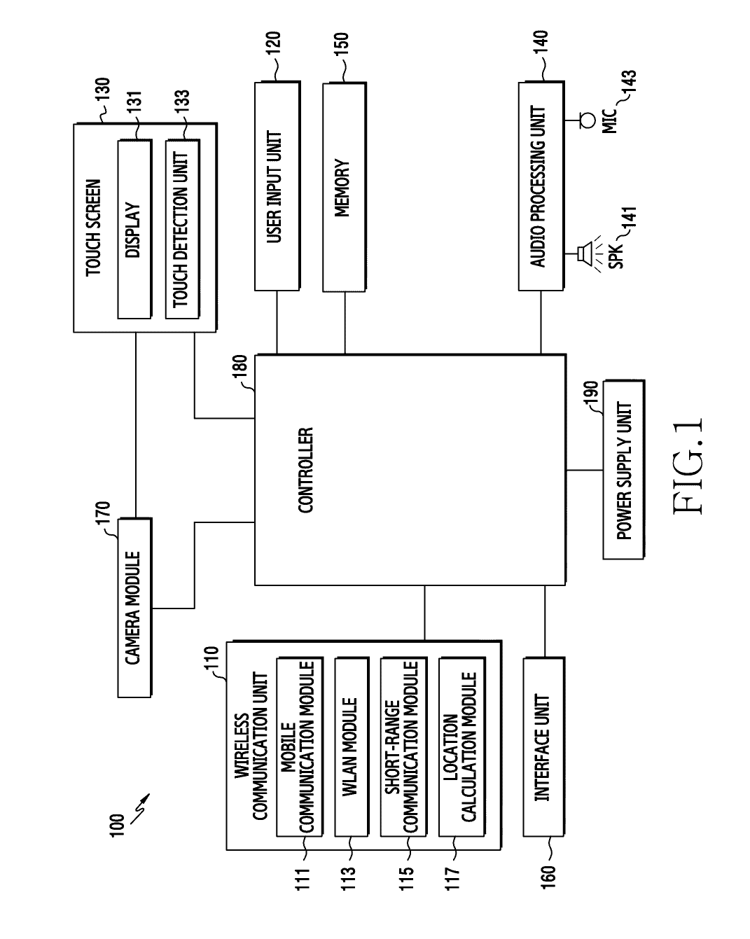

FIG. 1 is a block diagram schematically illustrating a configuration of an electronic device according to an embodiment of the present disclosure.

Referring to FIG. 1, an electronic device 100 according to embodiments of the present disclosure includes a wireless communication unit 110, a user input unit 120, a touch screen 130, an audio processor 140, a memory 150, an interface unit 160, a camera module 170, a controller 180, and a power supply unit 190. The electronic device 100 may include more or fewer elements than the elements of FIG. 1.

The wireless communication unit 110 includes one or more modules enabling wireless communication between the electronic device 100 and an external electronic device. The wireless communication unit 110 includes a module (for example, a short-range communication module, a long-range communication module, or the like) for communicating with an external electronic device around the electronic device 100. For example, the wireless communication unit 110 includes a mobile communication module 111, a wireless local area network (WLAN) module 113, a short range communication module 115, and a location calculation module 117.

The mobile communication module 111 transmits/receives a wireless signal to/from at least one of a base station, an external electronic device, and various servers (e.g., an integration server, a provider server, a content server, an Internet server, and a cloud server) on a mobile communication network. The wireless signal includes a voice call signal, a video call signal, or data in various forms according to the transmission and reception of text/multimedia messages.

The mobile communication module 111 transmits/receives a wireless signal to/from at least one of a base station, an external electronic device, and various servers (for example, an integration server, a provider server, a content server, an Internet server, and a cloud server) on a mobile communication network. The wireless signal includes a voice signal, a data signal, or various forms of control signal. The mobile communication module 111 transmits various pieces of data required for the operations of the electronic device 100 to the external device (for example, a server, another electronic device, or the like), in response to a user's request.

The mobile communication module 111 transmits/receives a wireless signal based on various communication schemes such as long-term evolution (LTE), LTE-advanced (LTE-A), global system for mobile communication (GSM), enhanced data GSM environment (EDGE), code division multiple access (CDMA), wideband CDMA (WCDMA), universal mobile telecommunications system (UMTS), or orthogonal frequency division multiple access (OFDMA) but are not limited thereto.

The WLAN module 113 is for establishing wireless internet access and a WLAN link with other external devices, and may be mounted inside or outside the electronic device 100. Wireless Internet technology includes Wi-Fi, wireless broadband (Wibro), world interoperability for microwave access (WiMax), high speed downlink packet access (HSDPA), millimeter wave (mmWave), or the like. The WLAN module 113 may be linked to an external electronic device connected to the electronic device 100 through a network (for example, a wireless Internet network) and transmit or receive various pieces of data of the electronic device 100 from or to the outside (for example, the external electronic device or the server). The WLAN module 113 may always maintain an on-state, or may be turned on based on settings of the electronic device 100 or a user input.

The short-range communication module 115 may be a module for performing short-range communication. Bluetooth™, Bluetooth low energy (BLE), radio frequency identification (RFID), infrared data association (IrDA), ultra wideband (UWB), ZigBee™, near field communication (NFC), or the like may be used as a short-range communication technology. The short-range communication module 115 may be linked with an external electronic device (for example, an external sound device) connected to the electronic device 100 through a network (for example, a short-range communication network) and transmit or receive various pieces of data of the electronic device from or to the external electronic device. The short-range communication module 115 may always maintain an on-state, or may be turned on based on settings of the electronic device 100 or a user input.

The location calculation module 117 is for obtaining the location of the electronic device 100, and includes a global positioning system (GPS) module as a representative example. The location calculation module 117 may measure the location of the electronic device 100 through a triangulation principle. For example, the location calculation module 117 may calculate three-dimensional current location information according to a latitude, a longitude, and an altitude, by calculating distance information and time information on the location away from three or more base stations and then applying trigonometry to the calculated information. Alternatively, the location calculation module 117 may calculate location information by continuously receiving location information of the electronic device 100 from three or more satellites in real time. The location information of the electronic device 100 may be obtained by various methods.

The user input unit 120 generates input data for controlling the operation of the electronic device 100 in response to a user input. The user input unit 120 includes at least one input device for detecting various user inputs. For example, the user input unit 120 includes a keypad, a dome switch, a physical button, a touch pad (resistive type/capacitive type), a jog & shuttle, and a sensor.

The user input unit 120 may be implemented in the form of buttons located outside the electronic device 100 or some or all of the user input unit 120 may be implemented in the form of touch panel. The user input unit 120 receives a user input for initiating the operation of the electronic device 100 (for example, a function of visualizing tempo progress information of elements of a music application) according to embodiments of the present disclosure and generate an input signal according to the user input.

The touch screen 130 is an input/output device for simultaneously performing an input function and a display function, and includes a display 131 and a touch detection unit 133. The touch screen 130 provides an input/output interface between the electronic device 100 and the user, transfer a user's touch input to the electronic device 100, and serve as a medium that shows an output from the electronic device 100 to the user. The touch screen 130 displays a visual output to the user in a form of text, graphics, video, or a combination thereof. The touch screen 130 displays various screens according to the operation of the electronic device 100 through the display 131. The touch screen 130 detects an event (for example, a touch event, a proximity event, a hovering event, or an air gesture event) based on at least one of a touch, hovering, and air gesture by the user through the touch detection unit 133 while a particular screen is displayed through the display 131, and transmit an input signal according to the event to the controller 180.

The display 131 displays various pieces of information processed by the electronic device 100. For example, when the electronic device 100 plays a plurality of elements (for example, a first music and a second music) in the music application, the display 131 displays a user interface (UI) or a graphical UI (GUI) related to displaying tempo progress information of each of the elements. The display 131 displays a UI or a GUI related to the electronic device 100 of visualizing and displaying musical attributes of a plurality of elements in the music application.

The display 131 supports screen displaying based on a landscape mode, screen displaying based on a portrait mode, or screen displaying based on a change between the landscape mode and the portrait mode, according to a rotation direction (or an orientation) of the electronic device 100. Various types of displays may be used as the display 131. According to embodiments, a bended display may be used as the display 131. For example, the display 131 includes the bended display which can be bent or folded without any damage due to a paper-thin and flexible substrate.

The bended display may maintain the bent form while being coupled to a housing (for example, a body). The electronic device 100 may be implemented as a display device, which can be quite freely folded and unfolded such as a flexible display, including the bended display. According to embodiments, in a liquid crystal display (LCD), a light emitting diode (LED) display, an organic LED (OLED) display, an active matrix OLED (AMOLED) display, or electronic paper, the display 131 may replace a glass substrate surrounding liquid crystal with a plastic film to assign flexibility to be folded and unfolded. The display 131 may be coupled to the electronic device 100 while extending to at least one side (for example, at least one of the left side, right side, upper side, and lower side) of the electronic device 131.

The touch detection unit 133 may be mounted on the display 131, and detects a user input that is in contact with or in proximity to the surface of the touch screen 130. The user input includes a touch event or a proximity event that is input based on at least one of a single-touch, a multi-touch, hovering, and an air gesture. The touch detection unit 133 receives a user input, such as a tap, drag, sweep, flick, swipe, flick, drag&drop, or drawing gesture such as a writing, for initiating the operation related to the use of the electronic device 100 and generates an input signal according to the user input.

The touch detection unit 133 may be configured to convert a change in pressure applied to a specific portion of the display 131 or a change in electrostatic capacitance generated at a specific portion of the display 131 into an electric input signal. The touch detection unit 133 detects a location and an area of the surface of the display 131 which an input means (for example, a user's finger, an electronic pen, or the like) contacts or approaches. The touch detection unit 133 may be implemented to also detect pressure when the touch is made according to the applied touch type. When there is a touch or proximity input on the touch detection unit 133, a signal(s) corresponding to the touch or proximity input may be transferred to a touch screen controller (not illustrated). The touch screen controller (not illustrated) processes the signal(s), and then transmit corresponding data to the controller 180. Accordingly, the controller 180 determines which area of the touch screen 130 is touched or approached, and process execution of a function corresponding to the touch or proximity.

The audio processing unit 140 performs a function of transmitting an audio signal received from the controller 180 to a speaker (SPK) 141 and transferring an audio signal such as a voice or the like, which is received from a microphone 143, to the controller 180. The audio processing unit 140 may convert voice/sound data into an audible sound through the speaker 141 based on the control of the controller 180, output the audible sound, convert an audio signal such as a voice or the like which is received from the microphone 143 into a digital signal, and transfer the digital signal to the controller 180. The audio processor 140 outputs an audio signal corresponding to a user input according to audio processing information (for example, an effect sound, a music file, or the like) inserted into data.

The speaker 141 outputs audio data that is received from the wireless communication unit 110 or stored in the memory 150. The speaker 141 outputs a sound signal associated with various operations (functions) executed by the electronic device 100. Attachable and detachable earphones, a headphone, or a headset may be connected to the speaker 141 of the electronic device 100 through an external port.

The microphone 143 receives an external sound signal and process the same into electrical voice data. Various noise reduction algorithms may be implemented in the microphone 143 to remove noise generated in the process of receiving an external sound signal. The microphone 143 serves to input an audio stream such as a voice command (for example, a voice command for initiating the music application). The microphone 143 includes an internal microphone mounted into the electronic device 100 or an external microphone connected to the electronic device.

The memory 150 stores one or more programs executed by the controller 180 and also perform a function of temporarily storing input/output data. The input/output data includes, for example, video, image, photo, and audio files. The memory 150 serves to store acquired data, and stores data acquired in real time in a temporary storage device and data, which is decided to be stored, in a storage device which can store the data for a long time.

The memory 150 stores instructions to perform a function of synchronizing tempo progress information on each of a plurality of elements (for example, first music and second music) and performing a function of displaying a visual effect along with an audio output in embodiments. The memory 150 stores instructions to instruct the controller 180 (for example, one or more processors) to synchronize tempos of first music (for example, project) and second music (for example, sound sample) based on at least a part of the tempo (for example, speed or BPM) of the first music or the second music and to output a relevant visual effect (for example, visually output tempo progress information based on a metronome) while outputting audio data of the first music and audio data of the second music when the instructions are executed.

The memory 150 may permanently or temporarily store an operating system (OS) of the electronic device 100, a program related to an input and display control using the touch screen 130, a program related to a control of various operations (functions) of the electronic device 100, and various pieces of data generated by the operations of the programs.

The memory 150 includes an extended memory (for example, external memory) and an internal memory. The memory 150 includes at least one type of storage medium of a flash memory type memory, a hard disk type memory, a micro type memory, a card type memory (for example, a secure digital (SD) card, an extreme digital (XD) card, or the like), a dynamic random access memory (DRAM), a static RAM (SRAM), a read-only memory (ROM), a programmable ROM (PROM), an electrically erasable PROM (EEPROM), a magnetic RAM (MRAM), a magnetic disk, and an optical disk. The electronic device 100 may also operate in relation to a web storage performing a storage function of the memory 150 on the Internet.

The memory 150 stores various software. For example, software components includes an operating system software module, a communication software module, a graphic software module, a user interface software module, a motion picture experts group (MPEG) module, a camera software module, and one or more application software module. Further, since the module, which is the component of software, may be expressed as a set of instructions, the module may be also expressed as an instruction set. The module may be also expressed as a program.

The operating system software module includes various software components for controlling a general system operation. Controlling the general system operation may refer to, for example, managing and controlling a memory and controlling and managing power. The operating system software module performs a function of smoothly executing communication between various hardware (devices) and software components (modules).

The communication software module may allow the electronic device to communicate with another electronic device such as a computer, a server, or a portable terminal through the wireless communication unit 110. The communication software module may be formed in a protocol structure corresponding to an appropriate communication scheme.

The graphic software module includes various software components for providing and displaying graphics on the touch screen 130. The term “graphics” includes text, web page, icon, digital image, video, animation, and the like.

The user interface software module includes various software components related to a user interface (UI). For example, the user interface software module includes the content indicating how a state of the user interface is changed or indicating a condition under which the change in the state of the user interface is made.

The MPEG module includes a software component which enables a digital content (for example, video and audio data)-related process and functions thereof (for example, generation, reproduction, distribution, and transmission of contents).

The camera software module includes a camera-related software component which enables camera-related processes and functions.

The application module includes a web browser including a rendering engine, email, instant message, word processing, keyboard emulation, address book, widget, digital rights management (DRM), iris scan, context cognition, voice recognition, and a location-based service. The application module processes an operation (function) for synchronizing tempos of a first music (for example, project) and a second music (for example, sound sample) based on at least a part of the tempo (for example, speed or BPM) of the first music or the second music and providing a relevant visual effect (for example, visually output tempo progress information based on a metronome) while outputting audio data of the first music or audio data of the second music.

The interface unit 160 receives data or power from an external electronic device, and may transfer the same to each element included in the electronic device 100. The interface unit 160 may enable the data within the electronic device 100 to be transmitted to an external electronic device. For example, the interface unit 160 includes a wired/wireless headset port, an external charger port, a wired/wireless data port, a memory card port, a port for connecting a device provided with an identification module, an audio input/output port, a video input/output port, an earphone port, and the like.

The camera module 170 corresponds to an element that supports a photography function of the electronic device 100. The camera module 170 photographs a predetermined subject according to a control of the controller 180 and transmits photographed data (for example, an image) to the display 131 and the controller 180. The camera module 170 includes one or more image sensors such as a front sensor (for example, a front camera) located on the front surface of the electronic device 100 (the same plane as the display 131) and a rear sensor (for example, a rear camera) located on the rear surface (for example, back surface) of the electronic device 100.

The controller 180 controls a general operation of the electronic device 100. For example, the controller 180 performs various controls related to music play, metronome function processing, visual processing of musical attributes, voice communication, data communication, video communication, and the like. The controller 180 may be implemented as one or more processors or may be referred to as a processor. For example, the controller 180 includes a communication processor (CP), an application processor (AP), an interface such as a general purpose input/output (GPIO), or an internal memory, as a separate element, or integrate them into one or more integrated circuits. The application processor may execute various software programs to perform various functions for the electronic device 100, and the communication processor processes and control voice communication and data communication. The controller 180 serves to execute a particular software module (instruction set) stored in the memory 150 and perform various particular functions corresponding to the module.

The controller 180 processes an operation for visualizing tempo progresses of a first music (for example, project) and a second music (for example, sound sample) based on at least a part of the tempo (for example, speed or BPM) of the first music or the second music and outputting a relevant visual effect (for example, visually output tempo progress information based on a metronome) while outputting audio data of the first music and audio data of the second music. The control operation of the controller 180 according to embodiments of the present disclosure will be described with reference to the drawings described below.

The controller 180 according to an embodiment of the present disclosure controls various operations related to the general functions of the electronic device as well as the above described functions. For example, when a specific application is executed, the controller 180 controls an operation and a screen display of the specific application. The controller 180 receives input signals corresponding to various touch event or proximity event inputs supported by a touch-based or proximity-based input interface (for example, the touch screen 130) and controls execution of functions according to the received input signals. In addition, the controller 180 controls transmission/reception of various types of data based on wired communication or wireless communication.

The power supply unit 190 receives external power or internal power based on the control of the controller 180, and may supply power required for the operation of each element. According to an embodiment of the present disclosure, the power supply unit 190 may supply or block (on/off) power to the display 131 and the camera module 170 under a control of the controller 180.

The embodiments of the present disclosure may be implemented in a recording medium, which can be read through a computer or a similar device, by using software, hardware, or a combination thereof. According to the hardware implementation, the embodiments of the present disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, micro-processors, and electrical units for performing other functions.

According to an embodiment of the present disclosure, the recording medium may be a computer-readable recording medium having a program recorded therein to execute operations including displaying music play and tempo progress information of music based on a user interface, detecting an event during the music play, and synchronizing the played music and the tempo progress information of the music according to the event and outputting the synchronized music and tempo progress information.

In some cases, the embodiments described in the present specification may be implemented by the controller 180 in itself. For software implementation, the embodiments such as procedures and functions described in this specification may be implemented by separate software modules that perform one or more functions and operations described in the present specification.

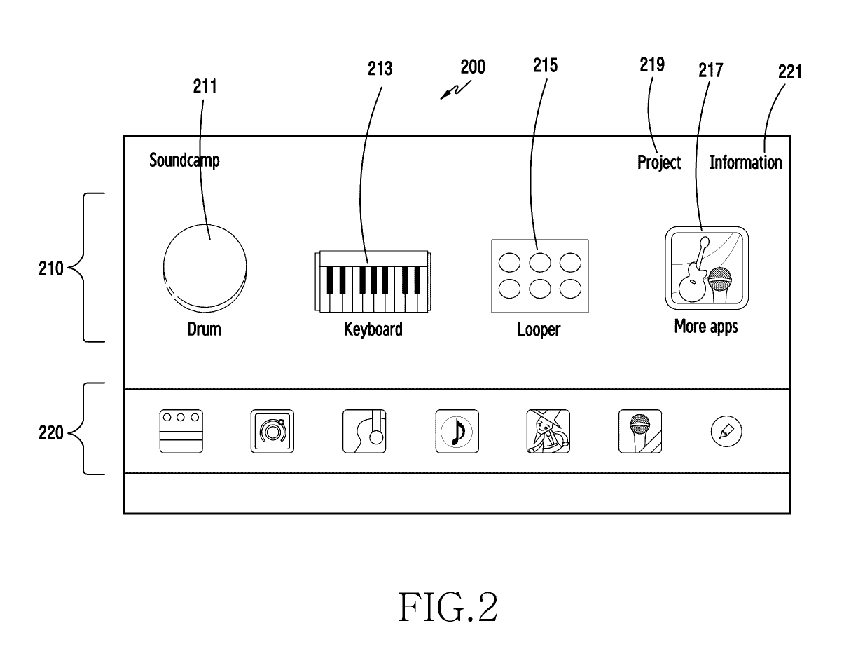

FIG. 2 illustrates an example of a user interface of a music application according to an embodiment of the present disclosure.

Referring to FIG. 2, FIG. 2 illustrates an example of a screen interface when a music application is executed in an electronic device. The music application includes a mobile digital audio workstation (DAW) application.

As illustrated in FIG. 2, a music application 200 includes a virtual musical instrument area 210 that provides information on virtual musical instruments installed in a plug-in type in advance. The music application 200 includes, below the virtual musical instrument area 210, an application area 220 that includes objects (for example, icons or images) of a virtual musical instrument application or an effecter application, which can be installed or downloaded by the music application 200, and supports the downloading of the corresponding application.

When a particular object (for example, a particular musical instrument) is selected in the virtual musical instrument area 210, the virtual musical instrument area 210 may be switched to a screen of an application related to the selected object (for example, a music play-related screen of the particular musical instrument, that is, a virtual play screen corresponding to a musical instrument such as a piano keyboard, drum, guitar, or the like). When a particular object is selected in the application area 220, the virtual musical instrument area 210 may be switched to a screen of an application related to the selected object (for example, a screen for displaying and downloading application information).

The virtual musical instrument area 210 includes objects (for example, icons or images) corresponding to musical instruments such as a drum 211, a keyboard 213, and a looper 215 provided in a plug-in type through various third parties and an object 217 for identifying another musical instrument or applications which are not displayed on the current screen.

The music application 200 includes a project menu 219 and an information menu 221. The project menu 219 includes a menu for displaying a list of a pre-stored project and indicates an audio file in which a performance and an effect by at least one virtual musical instrument are generated as one package. For example, the project includes one composition result. The project may be generated when the user records and stores music according to a performance, composition, or arrangement (for example, editing a track) using a virtual musical instrument within the electronic device or an external musical instrument connected to the electronic device through a wire or wirelessly. The user generates a new project by selecting a particular project and controlling a starting position of the recorded track, a played section, a played musical instrument, or an effect in the corresponding project (for example, recorded audio file).

According to embodiments, an information menu 221 may correspond to a menu for identifying information related to the music application 200 such as an update of the music application 200, open source license, music application information, a trailer, or user agreement.

The music application 200 may further provide information on the music application (for example, a name or soundcamp) to the virtual musical instrument area 210.

The user selects (for example, touch) an object corresponding to a virtual musical instrument in the virtual musical instrument area 210 to execute the corresponding virtual musical instrument. When the electronic device detects the selection of the virtual musical instrument by the user, the electronic device may execute the selected musical instrument and display a screen interface related to the execution of musical instrument. The user selects the corresponding object 211 in order to execute a drum application (for example, drum performance (or composition, arrangement, or the like)), and the electronic device displays a screen interface related to a virtual drum instrument in response to the selection of the object 211. The user selects the corresponding object 215 in order to execute a looper application (for example, loop performance (or composition, arrangement, or the like)), and the electronic device displays a screen interface related to the virtual looper application (or looper instrument) in response to the selection of the object 215.

The looper application may correspond to a sub application within the music application for playing music (for example, loop performance) by a plurality of cells of a looper area. The looper application is a type of virtual musical instrument such as a drum, piano, or guitar, and may be referred to as a looper instrument. A screen interface of the looper application will be described as an example.

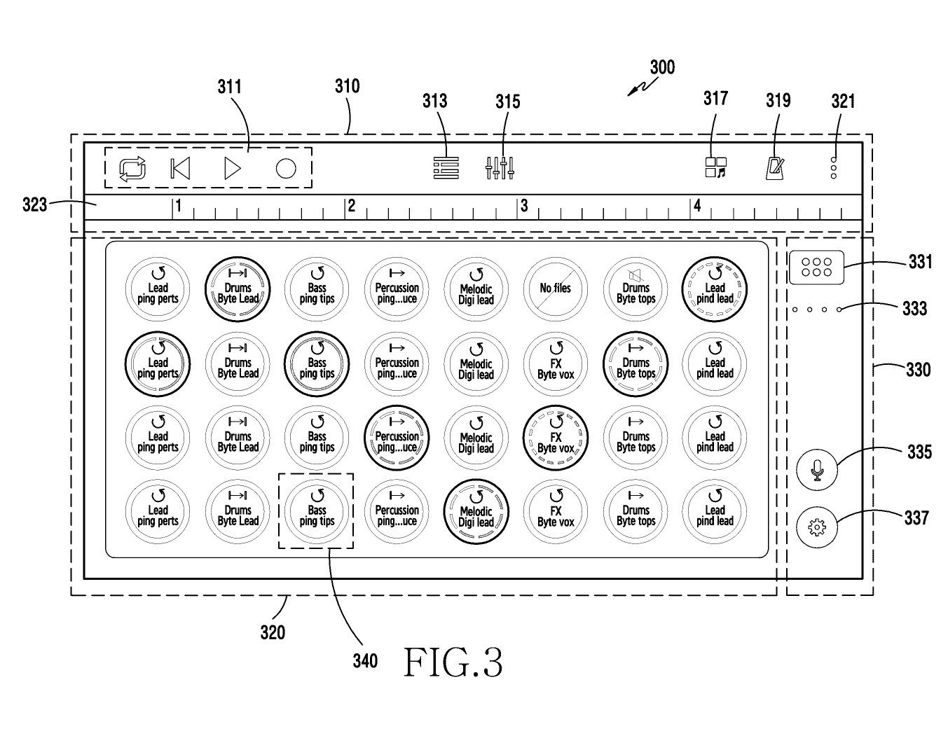

FIG. 3 illustrates an example of a user interface of a music application according to embodiments of the present disclosure.

Referring to FIG. 3, FIG. 3 illustrates an example of a screen interface when a looper application 300 among sub applications (for example, a musical instrument application, a looper application, and an effecter application) included in the music application is executed in the electronic device. The looper application 300 may be executed within the music application 200 in response to the selection of the looper object 215 in the screen interface of FIG. 2.

The looper application 300 includes a plurality of cells (for example, a plurality of button objects having a particular arrangement) that import sound samples (or music samples), and may indicate a musical instrument or a musical instrument software that is played through the generation of a sound in at least one cell. The looper application 300 includes an audio reproduction system which can reproduce a plurality of sound samples (or audio loop) at the same time. The sound samples (or samples) may generally indicate all sounds coming from the outside. For example, the sound sample includes a music file having an extension of way or mp3, and may be used as a drum sample or vocal sample. The loop is one type of sample and may indicate a continuously repeated sample. For example, the sample may be repeated in the unit of bars of music (for example, four bars, eight bars, or sixteen bars).

As illustrated in FIG. 3, the looper application 300 includes a basic control area 310 for the general control of the music application 200, a looper area 320 including a plurality of cells, and a looper control area 330 for the control related to the looper application 300 or each cell of the looper area 320.

The basic control area 310 may correspond to an area including menus for controlling total execution options (for example, various functions or modes) of the music application 200. The basic control area 310 includes a play control object 311 including buttons (for example, transport buttons) for functions of repeat section, rewind, play, pause, and record, an object 313 for editing tracks of virtual musical instruments included in the project, an object 315 for adjusting equalizers of the virtual musical instruments included in the project, an object 317 for setting genres or tones of the virtual musical instruments a metronome object 319 (for example, a project metronome) for turning on/off a metronome function, an object 321 for adjusting metronome related options (for example, a beat, BPM, and volume), and a track area 323 (or timeline area) for providing a play state of the project (for example, a track progress state).

When the metronome object 319 is activated (turned on) the metronome function may operate. For example, the metronome function outputs regular metronome sounds according to the set metronome related option (for example, the beat, BPM, or volume) (for example, every beat timing). The metronome function may enable the metronome object 319 itself or a flickering object, which is provided adjacently to the metronome object 319, regularly flicker (for example, a lamp flickering type) according to the metronome related option.

For example, when it is assumed that the project corresponds to four-four time, the metronome object 319 may flicker in four-four time of “one-two-three-four, one-two-three-four, . . . ”, and a flickering speed may correspond to a tempo or BPM of the project. The time may be variously set as 4/4, 3/4, 6/8. The speed may be variously set from BPM 40 to BPM 240, for example, very slow (BPM 40), slow (BPM 66), slow to moderate (BPM 76), moderate (BPM 108), moderate to fast (BPM 120), fast (BPM 168), and very fast (BPM 200-BPM 240), but is not limited thereto.

According to embodiments, in the looper application 300, the project may be selected or switched using the basic control area 310, another musical instrument may be selected, and the selected musical instrument may be played. In this case, a sound sample of at least one cell 340 selected in the lopper area 320 of the looper application 300 and a sound of a project or a musical instrument selected through the basic control area 310 may be independently output.

The looper area 320 is an area in which a plurality of buttons (hereinafter, cells) 340 including various genres of sound samples are arranged, and may indicate a music work window. The user selects (for example, touch) at least one cell in the looper area 320 and combine and play various sound effects. The loop may indicate repetition of a melody or beat in the same music pattern.

In the looper area 320, the plurality of cells 340 may be arranged in, for example, various matrix structures but are not limited thereto. The plurality of cells 340 may indicate objects that define at least one of other various musical attributes by importing at least one sound sample (for example, sound sample of the musical instrument). The plurality of cells 340 may import the same musical instrument or genre based on a row or column, and import different musical instruments or genres based on the row or column. For example, the plurality of cells 340 may import the same musical instrument or genre according to each row and import different musical instruments or genres according to each column.

According to embodiments, each of the cells 340 may express one or more visual effects corresponding to the defined musical attributes. A color light (for example, glow effect) may be output from an activated cell, which plays a sound sample according to the selection, among the cells 340 or at least some of the areas around the activated cell. The looper area 320 may express musical attributes (for example, mood) of the sound sample imported into each cell with a representative color through each cell 340. The same color may be designated to each row or each column of the cells 340 in order to express the same mood.

The looper control area 330 may correspond to an area including menus for controlling execution options (for example, various functions or modes) of the looper application 300. The looper control area 330 includes a view object 331 for changing a view type, a metronome object 333 (for example, metronome or looper metronome), which regularly or sequentially flickers according to an option set on the looper application 300 (for example, beat or tempo (for example, speed or BPM)), a record object 335 for additional recording of a current project (for example, project played in the background through the music application 200 or another musical instrument played in the background) based on the looper application 300, and a setting object 337 for controlling various options (for example, loop genre, musical instrument, beat, and BPM) related to the looper application 300 (for example, looper area 320).

The looper application 300 may correspond to a sub application within the music application for musical performance (for example, loop performance) by the plurality of cells 340 of the loop area 320, and may be referred to as a looper instrument according to the type of virtual musical instrument such as a drum, piano, or guitar.

According to an embodiment, for example, when it is assumed that the sound sample corresponds to four-four time, the metronome object 333 (for example, looper metronome) may sequentially flicker in four-four time of “one-two-three-four, one-two-three-four, . . . ”, and a flickering speed may correspond to a speed of the sound sample (for example, tempo or BPM). The time may be variously set as 4/4, 3/4, or 6/8, for example. The speed may be variously set from BPM 40 to BPM 240, such as very slow (BPM 40), slow (BPM 66), slow to moderate (BPM 76), moderate (BPM 108), moderate to fast (BPM 120), fast (BPM 168), and very fast (BPM 200 BPM 240), but is not limited thereto.

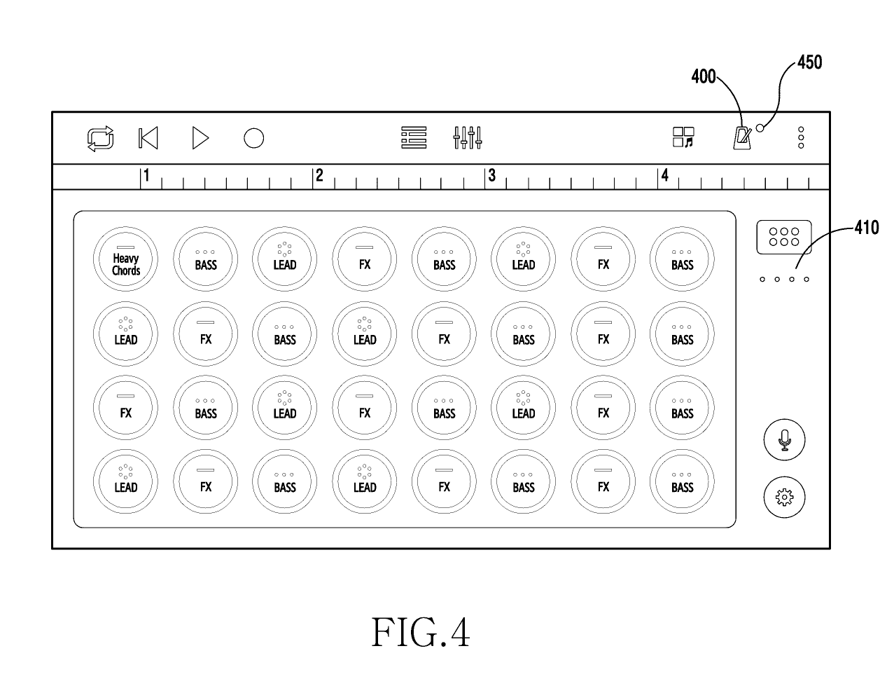

FIGS. 4, 5 and 6 illustrate examples of playing a sound sample in the electronic device according to embodiments of the present disclosure.

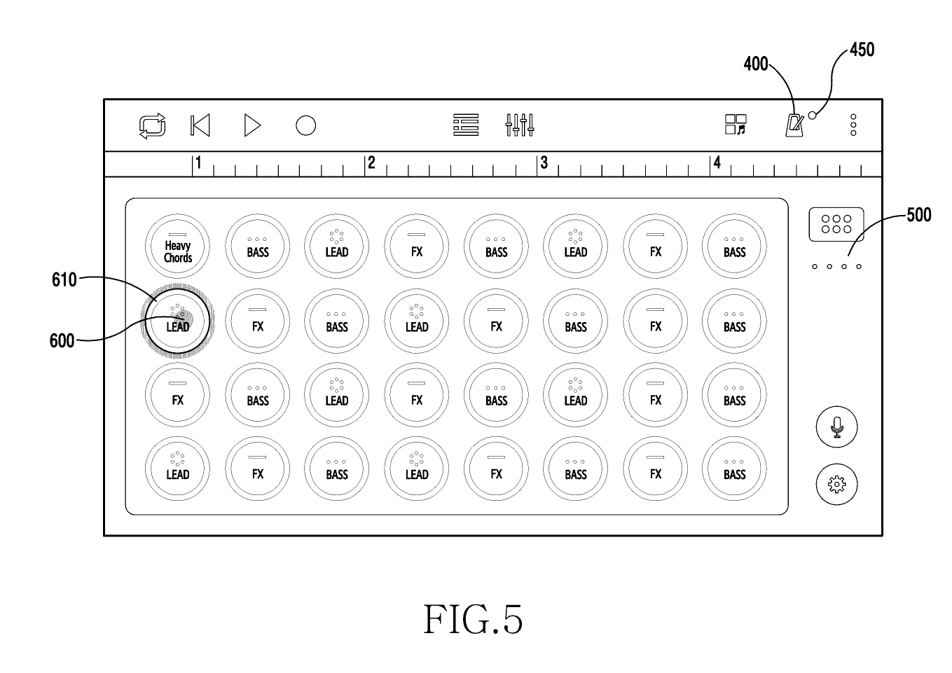

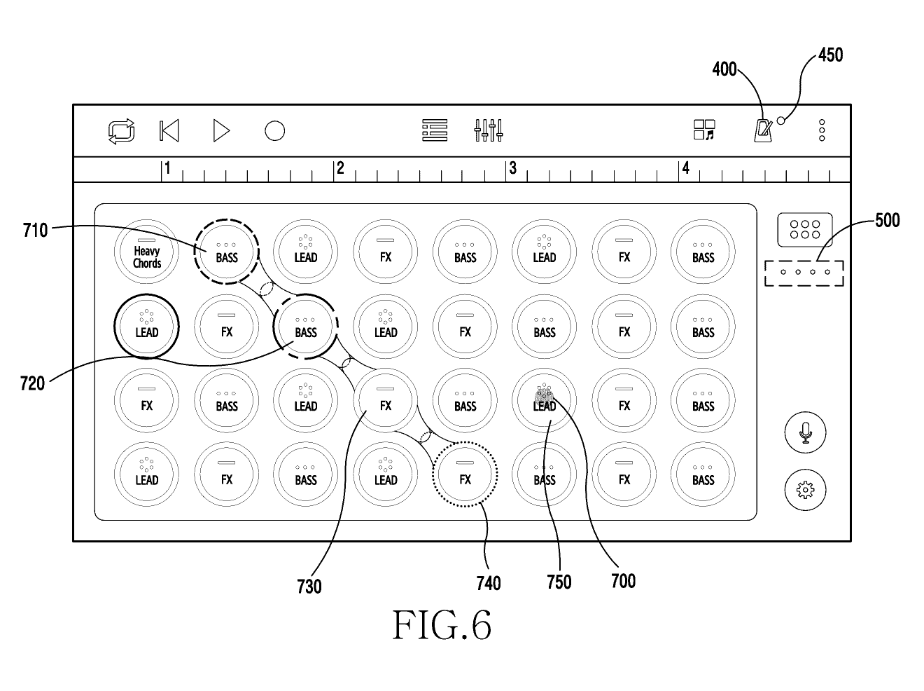

Referring to FIG. 4, FIG. 4 illustrates an example of a screen when the looper application is executed but is not played. In a state like FIG. 4, the user plays a sound sample through various user inputs. For example, the user selects a cell through a touch input as illustrated in FIG. 5. Alternatively, the user may successively select a plurality of cells through a drag input as illustrated in FIG. 6.

According to embodiments, as illustrated in FIG. 4, in a state where the looper application stands by (for example, before a second music (for example, at least one sound sample) is played)), a first music (for example, project) may be played (for example, audio output of the project) by the music application. In this case, a metronome function may be visually or acoustically provided by a metronome object 400 (a project metronome) for the first music (for example, project). The project metronome 400 itself of a flickering object 450 for visually displaying the metronome may regularly flicker in time with the beat of the played project.

The metronome object 400 or the flickering object 450 is to inform of a tempo (or time) progress of the project and is referred to as the project metronome hereinafter for convenience of the description. For example, the tempo progress of the project may be displayed through the project metronome 400.

Here, since the looper application is in the standby state, a metronome object 500 (a looper metronome) for a second music (for example, sound sample) may exist in the standby state without a separate acoustic or visual output.

Referring to FIG. 5, the user selects a particular cell 610 in the looper area. The user may input a touch 600 into the particular cell 610. The electronic device outputs a sound sample set on the cell 610 corresponding to the user's selection. The electronic device provides a visual effect based on musical attributes of the cell selected in response to the cell selection.

Referring to FIG. 6, the user selects a plurality of cells 710, 720, 730, 740, and 750 in the looper area. The user may input successive performance operations (for example, a drag 700 (or sweep) which sequentially pass through the other cells 720, 730, 740, and 750 after a touch input into the particular cell 710). The electronic device outputs sound samples set on the plurality of cells 710, 720, 730, 740, and 750 corresponding to the user selection. The electronic device provides a visual effect through each of the cells based on musical attributes of each of the plurality of cells selected in response to the cell selection. According to embodiments, cells included in the looper area may have a column-specific representative color, and the plurality of selected cells (for example, cells outputting sound samples) provides a visual effect of a performance operation with each representative color.

According to embodiments, at least one sound sample played according to a user input may be played once or repeatedly. Alternatively, at least one sound sample may be played while a user input (for example, a touch or a touch gesture) is maintained, and the play may stop at a time point when the user input is released.

According to embodiments, as illustrated in the example of FIG. 5 or 6, when at least one cell is selected in the looper area, a second music (for example, sound sample) of the selected cell may be played (for example, audio output of the sound sample). According to embodiments, a metronome function by the looper metronome may be operated in response to the playing of the sound sample. According to an embodiment, for example, the looper metronome 500 may regularly flicker in time with the tempo (e.g., speed, BPM, or time) of the sound sample that plays the looper metronome in time with the tempo corresponding to the looper application. For example, the tempo progress of the sound sample may be displayed through the looper metronome 500.

According to embodiments, a first music (for example, project) and second music (for example, sound sample) may independently operate based on different layers within one music application. For example, a layer (for example, a layer for playing a piano application) for the first music (for example, project) dependent on the music application based on the music application (for example, in a tree structure) and a layer (for example, a layer for playing the looper application) for the second music (for example, sound sample) may be implemented as different layers and operate independently from each other.

When the first music (for example, project) and the second music (for example, sound sample) operating as different layers are played, the progress of independent tempos of the respective music may be provided at the same time. For example, the tempo progress of the first music may be displayed through the project metronome 400 in time with the corresponding tempo, and the tempo progress of the second music may be displayed through the looper metronome 500 in time with the corresponding tempo. When the tempo progress corresponding to the first music and the second music is displayed, the first music and the second music may be synchronized and provided so that the tempos do not become off-tempo and are made to be in time with each other. For example, according to embodiments of the present disclosure, by synchronizing all tempos of a plurality of elements (for example, first music and second music) having independent tempos, the tempos of all the elements do not become off-tempo and are made to be in time with each other.

As described above, the electronic device 100 according to embodiments of the present disclosure includes a user interface, a memory 150, and one or more processors 180 electrically connected to the user interface and the memory, wherein the one or more processors are configured to display tempo progress information of music in response to playing of the music, to detect an event while the music is played, to synchronize the played music and tempo progress information of music according to the event, and to output the synchronized music and tempo progress information.

The user interface includes a basic control area for a general control of a music application, a looper area including a plurality of cells on which various sound samples are set, and a looper control area for controlling the plurality of cells. The basic control area and the looper control area includes a metronome object that outputs a metronome function of each played music.

The played music and the music according to the event may correspond to music which has different attributes and independently operates based on different layers. The music includes a first music in which a performance or an effect by at least one virtual musical instrument is configured as one package, and a second music that repeats a melody or a beat in an identical music pattern.

The processor may be configured to detect an event for the first music (for example, project) in the basic control area, to output tempo progress information corresponding to the first music through a metronome object (for example, project metronome) of the basic control area, to detect an event for the second music (for example, sound sample) in the looper area, and to output tempo progress information corresponding to the second music through a metronome object (for example, looper metronome) of the looper control area.

The processor may be configured to determine playing information related to the played music and the event music in response to the detection of the event while the music is played, and to synchronize a tempo of the played music and a tempo of the event music based on a result of the determination.

The processor may be configured to play a first music (for example, project), to display tempo progress information of the first music, to synchronize an event starting time point of a second music (for example, sound sample) with a next beat of the first music when detecting an event related to simultaneous playing of the second music, and to display tempo progress information of the first music and the second music with the same tempo. The processor may be configured to start the playing of the second music and the looper metronome in time with the next beat of the first music, and, in response to a control of the event starting time point of the second music, to move a location of an indicator indicating a play progress state to a location corresponding to the controlled event starting time point and display the moved indicator.

The processor may be configured to play a second music (for example, sound sample) and display tempo progress information of the second music, to play a first music (for example, project) in time with the tempo of the played second music when detecting an event related to simultaneous playing of the first music, and to display the tempo progress information in accordance with independent tempos of the first music and the second music.

The processor may be configured to stop playing the first music after playing the first music by a bit length defined to the first music, and to continuously maintain the playing of the second music when stopping playing the first music.

The memory may be configured to store instructions to instruct the one or more processors to display the tempo progress information of the music in response to the playing of the music, to detect the event while the music is played, and to synchronize and output the played music and the tempo progress information of the music according to the event when the instructions are executed.

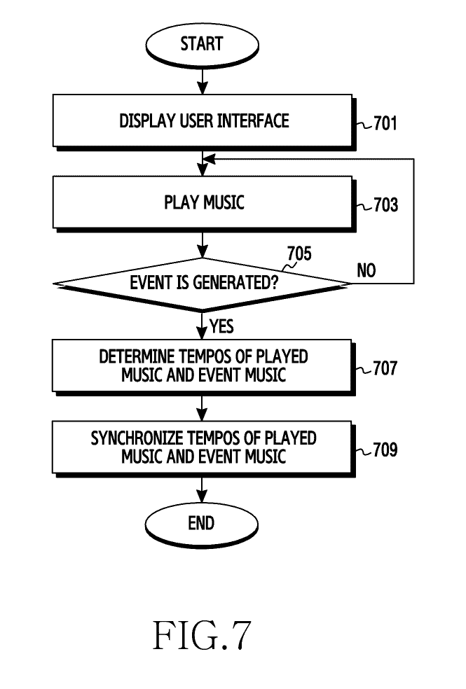

FIG. 7 illustrates an operation method of the electronic device according to embodiments of the present disclosure.

Referring to FIG. 7, in step 701, the controller 180 displays a user interface. For example, the user may enable a control to execute (user input) a music application by using the electronic device. The controller 180 may enable a control to execute the music application in response to the user's control of the execution of the music application and to display a user interface corresponding to the executed music application. The controller 180 may enable a control to display the aforementioned user interfaces corresponding to FIGS. 2 to 4.

In step 703, the controller 180 plays music (or performance) based on the user interface. For example, the user generates a user input for playing first music (for example, project) or playing second music (for example, sound sample) based on the user interface. When a user input for playing music is detected, the controller 180 plays the first music or the second music in response to the user input and process an audio output corresponding to the music. When playing the music, the controller 180 may enable a control to operate a corresponding metronome function according to attributes of the played music (for example, a project of a first layer or a sound sample of a second layer). According to an embodiment, when the music played according to the user input is the first music, the controller 180 processes the project metronome 400. When the music played according to the user input is the second music, the controller 180 processes the looper metronome 500.

In step 705, the controller 180 determines whether an event is generated. The event includes an operation event of, while music (for example, project or sound sample) of particular attributes is played, playing music of other attributes as described above.

When the generation of the event is not detected in step 705 (705: No), the controller 180 returns to step 703.

When the generation of the event is detected in step 705 (705: Yes), the controller 180 determines tempos of played music and event music in step 707. For example, the currently played music may be a first music or a second music, and music additionally played according to the event may be music of attributes different from those of the currently played music. When the played music is the project, the event music may be the sound sample. When the played music is the sound sample, the event music may be the project. When detecting playing of a plurality of musical elements (for example, the first music and the second music of different attributes) operating based on the tempo, the controller 180 determines the tempo (for example, speed or BPM) of each element.

In step 709, the controller 180 synchronizes tempos of the played music and the event music. For example, the controller 180 controls the tempos (for example, speed or BPM) of the first music and the second music played based on the tempo set on each thereof to have the same tempo. When synchronizing the tempos of the elements (first music and second music), the controller 180 may also synchronize and output metronome functions by the metronomes (for example, the project metronome 400 and the looper metronome 500) informing of the tempo progress of the first music and the second music. For example, the controller 180 may enable a control to acoustically or visually generate tempo process information of the elements through the metronomes at the same time.

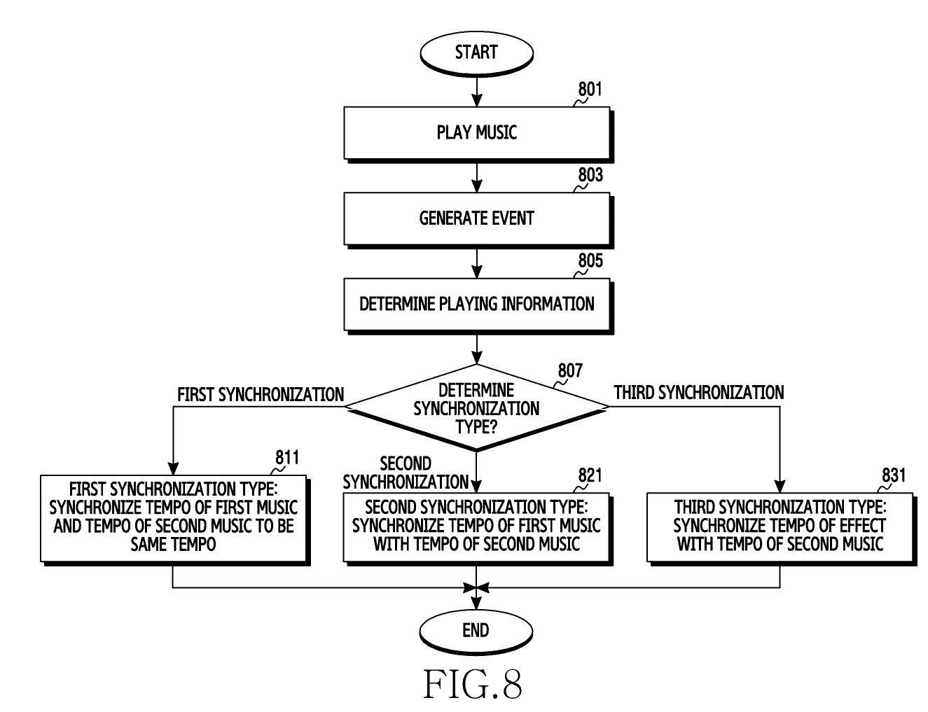

FIG. 8 illustrates a method of operating a music application in the electronic device according to embodiments of the present disclosure.

Referring to FIG. 8, in step 801, the controller 180 plays music. For example, the user generates a user input for playing the first music (for example, project) or playing second music (for example, sound sample) based on a user interface, and the controller 180 plays the first music or the second music based on the user input and process an audio output thereof.

In step 803, the controller 180 detects generation of an event while the music is played. For example, while the music of particular attributes is played, the controller 180 detects playing music of attributes different from those of the currently played music.

In step 805, the controller 180 determines play information in response to the detection of the event. The play information includes various pieces of information related to playing of a plurality of elements (for example, first music and second music) to be played, for example, attributes of the played music, attributes of music according to the event, a tempo of the played music, or a tempo of the event music.

In step 807, the controller 180 determines a synchronization type of the plurality of elements played based on the play information. According to embodiments, for example, when the played music (for example, attributes of the music) corresponds to the first music and the event music corresponds to the second music, the controller 180 determines a first synchronization type. When the played music corresponds to the second music and the event music corresponds to the first music, the controller 180 determines a second synchronization type. When the played music corresponds to the second music and the event music corresponds to music for setting (adding) an effect, the controller 180 determines a third synchronization type.

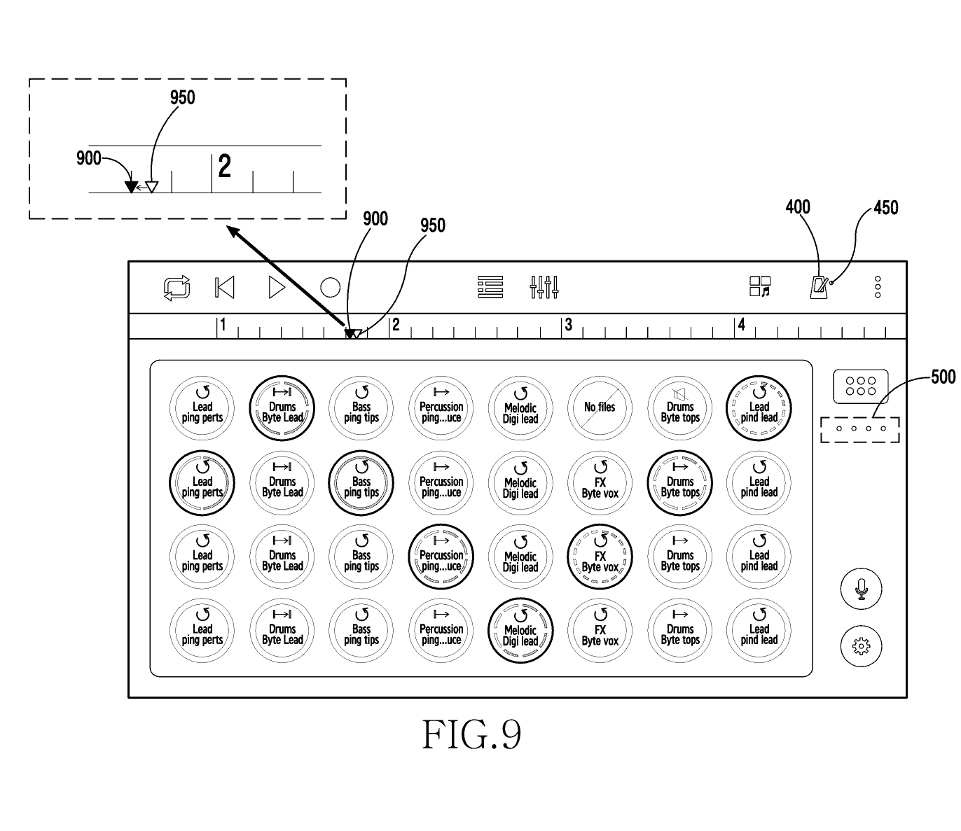

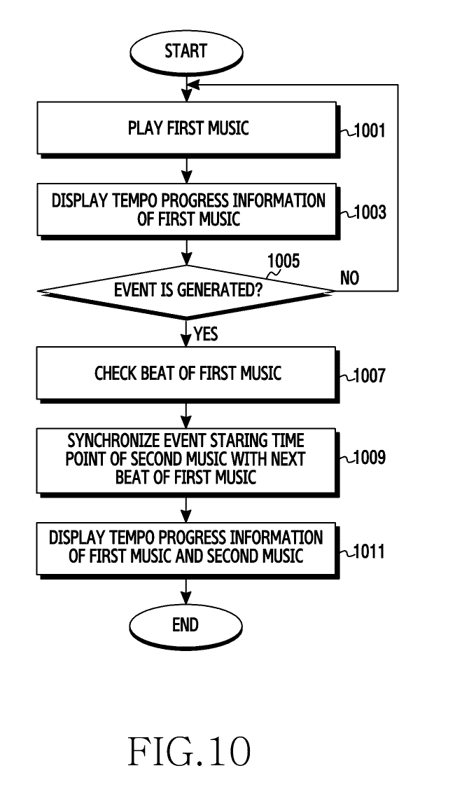

When the controller 180 determines the first synchronization type in step 807, the controller 180 synchronizes tempos of the first music and the second music according to the determined first synchronization type in step 811. For example, the controller 180 synchronizes the tempo of the played project and the tempo of the sound sample additionally played according to the event having the same tempo to be the same tempo. This will be described below with reference to FIGS. 9 and 10.

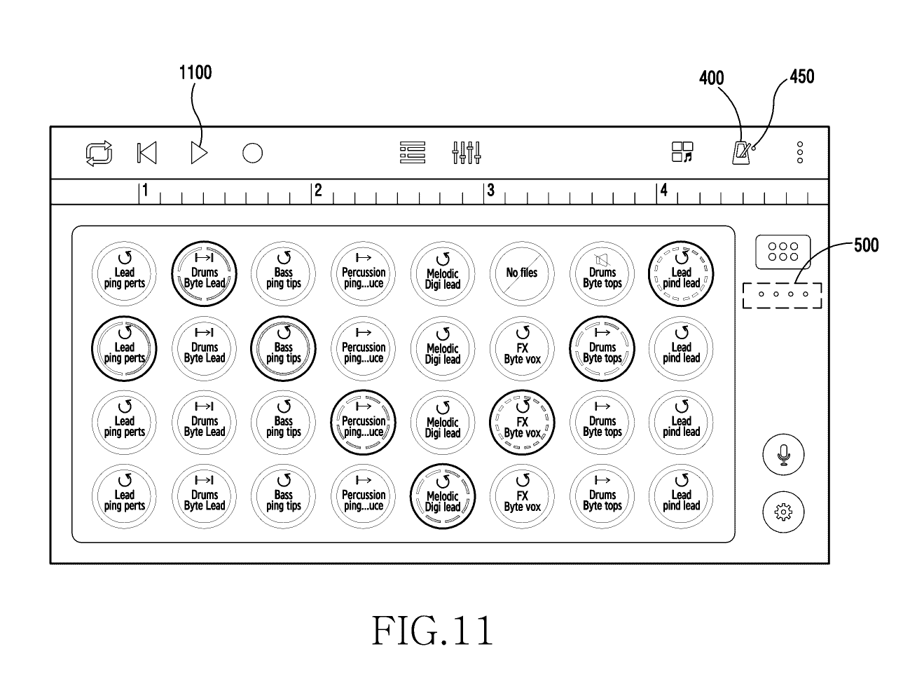

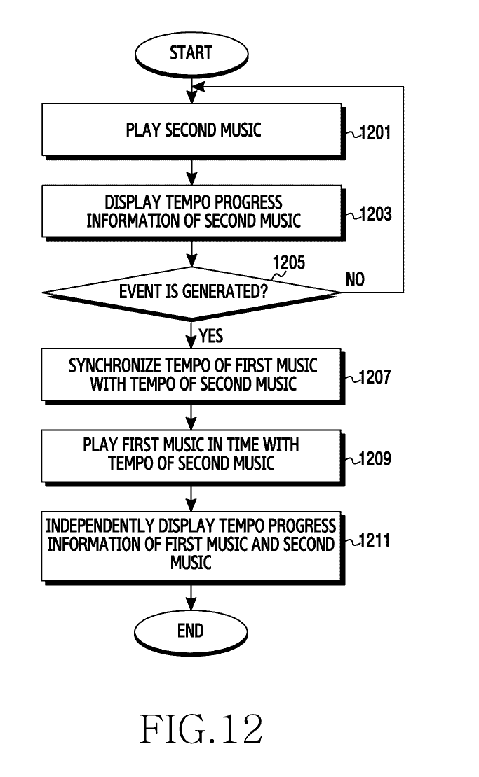

When the controller 180 determines the second synchronization type in step 807, the controller 180 synchronizes tempos of the first music and the second music according to the determined second synchronization type in step 821. For example, the controller 180 synchronizes the tempo of the project played according to the event with the tempo of the conventionally played sound sample. This will be described below with reference to FIGS. 11 and 12.

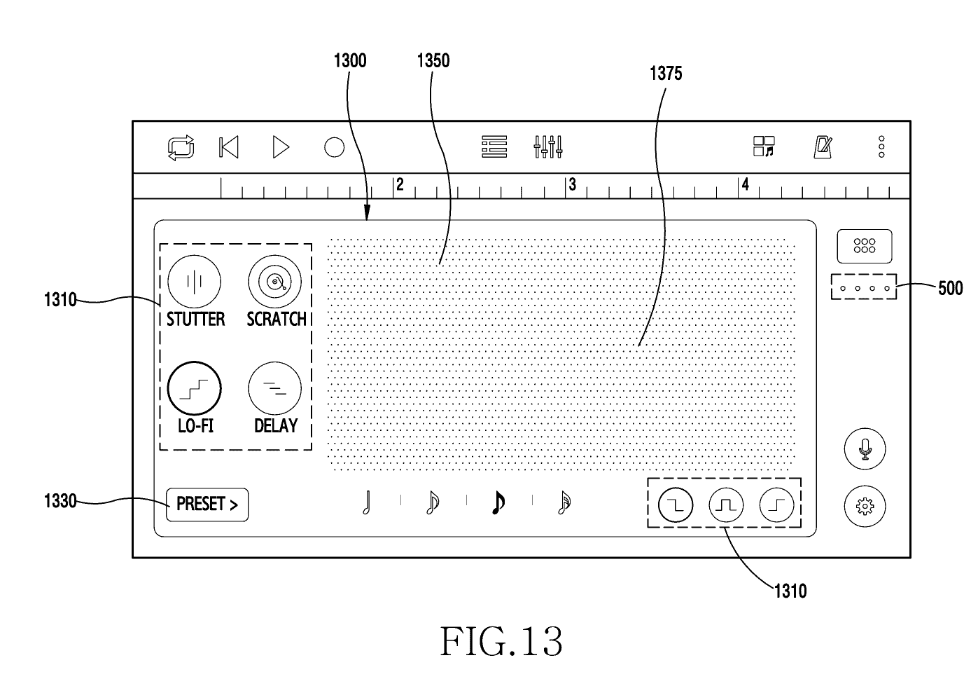

When the controller 180 determines the third synchronization type in step 807, the controller 180 synchronizes tempos of the first music (for example, effect) and the second music (for example, sound sample) according to the determined third synchronization type in step 831. For example, the controller 180 synchronizes the tempo of the effect played according to the event with the tempo of the conventionally played sound sample. This will be described below with reference to FIGS. 13, 14, and 15.

FIG. 9 illustrates an example for describing synchronizing tempos of different elements in the electronic device according to embodiments of the present disclosure.

FIG. 9 displays a state where a particular project (or musical instrument) is selected by the user and the selected project is played (for example, an audio output of the project). When the project is played (for example, audio output of the project), tempo progress information of the played project may be visually output (for example, displayed). The electronic device may visually provide the tempo progress in time with the tempo (or time) of the played project through the project metronome 400. For example, the flickering object 450 (for example, a point in the form of one lamp) of the project metronome 400 may regularly flicker in time with the tempo (for example, lamp flickering type).

When sound samples are played (for example, audio output of the sound samples) by one or more cells in the looper area, tempo progress information of the played sound sample may be visually output (for example, displayed). The electronic device may visually provide the tempo progress in time with the tempo of the played sound sample through the looper metronome 500. For example, flickering objects (for example, points in the form of four lamps) of the looper metronome 500 may regularly flicker sequentially (for example, lamp flickering type).

When playing the sound sample or the project, the electronic device provides a play progress state (for example, play location) through the track area 323 (or timeline area). For example, in the track area 323, an indicator 900 indicating the play progress state may be provided. The indicator 900 may move to the right side within the track area 323 in time with the tempo of the played music such as the project or the sound sample, and time information provided in the track area 323 may be switched to a scroll type according to the movement of the indicator 900.

According to embodiments, different music (elements) (for example, project and sound sample) having independent tempos may be simultaneously played. For example, while playing music of particular attribute (for example, project or sound sample), the user may enable a control to play music with other attributes (for example, sound sample or project).

The electronic device plays the project in time with a tempo A according to a user's control and provide tempo progress information of the tempo A through the project metronome 400. For example, the corresponding beat may be visually displayed (for example, regular flickering) according to the progress of the tempo A of the project through the flickering object 450. The electronic device detects a particular event related to playing of the sound sample while the project is played. The user performs a user input for selecting one or more cells in the looper area or a user input for initiating a recording operation by selecting a record button (for example, the record object 335 of FIG. 3) of the looper control area. The electronic device detects an event for playing a plurality of music (elements) with different attributes in response to the user input.

When the electronic device detects a particular event related to playing of the sound sample while the project is played in time with the tempo A, the electronic device provides tempo progress information of a tempo B of the sound sample through the looper metronome 500. For example, the corresponding beat may be visually displayed (for example, regular and sequential flickering by a plurality of flickering objects) according to the progress of the tempo B of the sound sample through the looper metronome 500.

While playing the project and providing the tempo progress information according to the tempo A of the project using the project metronome 400, the electronic device may also play the sound sample and provide the tempo progress information according to the tempo B of the sound sample using the looper metronome 500 in response to the detection of the event. The electronic device may enables a control to not start the operation of playing the sound sample and displaying the tempo progress information of the tempo B according to the event in time with the next beat of the tempo A of the project immediately but start in time with the next beat of the tempo A of the project. For example, the electronic device synchronizes the tempo A and the tempo B of the project and the sound sample such that the tempo A and the tempo B have the same tempo (for example, speed or BPM).

As described above, the electronic device performs the operation of synchronizing the tempo A of the played project and the tempo B of the sound sample according to the event. The electronic device processes the synchronization by controlling a starting time point such that the tempo B of the sound sample according to the event corresponds to the beat of the tempo A of the played project. For example, when it is assumed that the starting time point of the sound sample according to the generation of the event is a point of the indicator 950 in the track area 323, the electronic device may not start the playing of the sound sample according to the generation of the event and the operation of the looper metronome 500 at the point of the indicator 950 immediately but start them in time with the next beat of the project (for example, next beat indicated by the project metronome 400). The electronic device may move the event starting time point of the sound sample to the point of the indicator 900 to perform synchronization rather than to the point of the indicator 950. Accordingly, when providing each of the tempo progress information by the project metronome 400 and the looper metronome 500, the electronic device may simultaneously provide the tempo progress information without becoming off-beat.

FIG. 10 illustrates a method of synchronizing tempos of different elements in the electronic device according to embodiments of the present disclosure.

Referring to FIG. 10, the controller 180 plays first music in step 1001, and display tempo progress information of the first music in response to the playing of the first music in step 1003. For example, the electronic device plays a project (for example, process an audio output) in response to a user's control based on the aforementioned user interface and visually provide a tempo A of the project by the project metronome 400 in response to the played project.

In step 1005, the controller 180 determines whether an event is generated while processing the playing of the first music and the displaying of the tempo progress information of the first music. For example, the electronic device detects an event (for example, record start) related to simultaneous playing of a second music with different attributes (for example, a looper-based sound sample) in addition to the first music.

When the event is not detected in step 1005 (1005: No), the controller 180 returns to step 1001.

When the controller 180 detects the event in step 1005 (1005: Yes), the controller 180 may check a beat of the first music in step 1007. For example, the controller 180 may check beat information of the played project.

In step 1009, the controller 180 synchronizes an event starting time point of the second music (for example, at a time point when the second music is played and tempo progress information of the second music is displayed) with a next beat of the first music. For example, as described in the part with reference to FIG. 9, the controller 180 may not start the playing of the sound sample according to the generation of the event and the operation of the looper metronome 500 at the point of the indicator 950 immediately but start them in time with the next beat of the project (for example, next beat indicated by the project metronome 400). The controller 180 may move the event starting time point of the sound sample to the point of the indicator 900 to perform synchronization rather than to the point of the indicator 950.

In step 1011, the controller 180 displays the tempo progress information of each of the first music and the second music. For example, the controller 180 displays each of the tempo progress information based on the same tempo of the project metronome 400 and the looper metronome 500.

FIG. 11 illustrates an example for describing synchronizing tempos of different elements in the electronic device according to embodiments of the present disclosure.

FIG. 11 shows a state where at least one cell is selected in the looper area by the user and a sound sample of at least one selected cell is played (for example, audio output of the sound sample). According to embodiments, all cells included in the looper area may be implemented to output a sound sample by one cell according to each column (for example, respective columns have different mood attributes). When the sound sample is played (for example, audio output of the sound sample), tempo progress information of the played sound sample may be visually output or displayed. The electronic device may visually provide the tempo progress in time with the beat of the played sound sample through the looper metronome 500. For example, a plurality of independent flickering objects (for example, points in the form of four lamps) of the looper metronome 500 may regularly flicker sequentially (for example, lamp flickering type).

The electronic device plays the sound sample in time with the tempo B according to a user's control and provide tempo progress information of the tempo B through the looper metronome 500. The electronic device detects a particular event related to playing of the project while the sound sample is played. The user performs a user input for selecting (for example, touching) a play button (for example, a play object 311 of the play control object of FIG. 3) for playing the project in the basic control area or a user input for initiating a recording operation by selecting a record button (for example, a record object of the control object 311 of FIG. 3) in the basic control area. The electronic device detects an event for playing a plurality of music (elements) with different attributes in response to the user input.

When the electronic device detects a particular event related to the playing of the project while the sound sample is played in time with the tempo B, the electronic device provides tempo progress information of the tempo A of the project through the project metronome 400. For example, the corresponding beat may be visually displayed (for example, regular flickering by the flickering object 450) according to the progress of the tempo A of the project through the project metronome 400.

While playing the sound sample and providing the tempo progress information according to the tempo B of the sound sample using the looper metronome 500, the electronic device may also play the project and provide the tempo progress information according to the tempo A of the project using the project metronome 400 in response to the detection of the event. Here, the electronic device may start the playing of the project according to the event and the operation of displaying the tempo progress information of the tempo A such that the event generating time point matches the tempo B. For example, the electronic device performs synchronization such that the tempo B of the project according to the event matches the tempo B of the sound sample played before the generation of the event.

As described above, the electronic device performs the operation of synchronizing the tempo B of the played sound sample and the tempo A of the project according to the event. The electronic device processes the synchronization to play the project such that the tempo A of the project according to the event matches the beat of the tempo B of the played sound sample. For example, the operation of playing the project according to the generation of the event and displaying the project metronome 400 corresponding to the played project may be initiated to match the looper metronome 500 displaying the tempo of the played sound sample. Accordingly, when providing each of the tempo progress information by the looper metronome 500 and the project metronome 400, the electronic device may simultaneously provide the tempo progress information without becoming off-beat.

FIG. 12 illustrates a method of synchronizing tempos of different elements in the electronic device according to embodiments of the present disclosure.

Referring to FIG. 12, the controller 180 plays second music in step 1201, and display tempo progress information of the second music in response to the playing of the second music in step 1203. For example, the electronic device plays a sound sample (for example, process an audio output of the sound sample) in response to a user's control based on the aforementioned user interface and visually provide a tempo B of the sound sample by the looper metronome 500 in response to the played sound sample.

In step 1205, the controller 180 determines whether an event is generated while processing the playing of the second music and the displaying of the tempo progress information of the second music. For example, the controller 180 detects an event (for example, playing of the project) related to simultaneously playing of first music (for example, project) of different attributes in addition to the second music.

When the event is not detected in step 1205 (1205: No), the controller 180 returns to step 1201.

When the event is detected in step 1205 (1205: Yes), the controller 180 performs synchronization such that the tempo of the first music according to the event matches the tempo of the played second music in step 1207.

The controller 180 plays the first music according to the event in time with the tempo of the played second music in step 1209, and display tempo progress information of each of the first music and the second music in step 1211. For example, the controller 180 synchronizes play time points of the first music and the second music and display the tempo progress information in time with the independent tempos without off-beat of the project metronome 400 and the looper metronome 500.

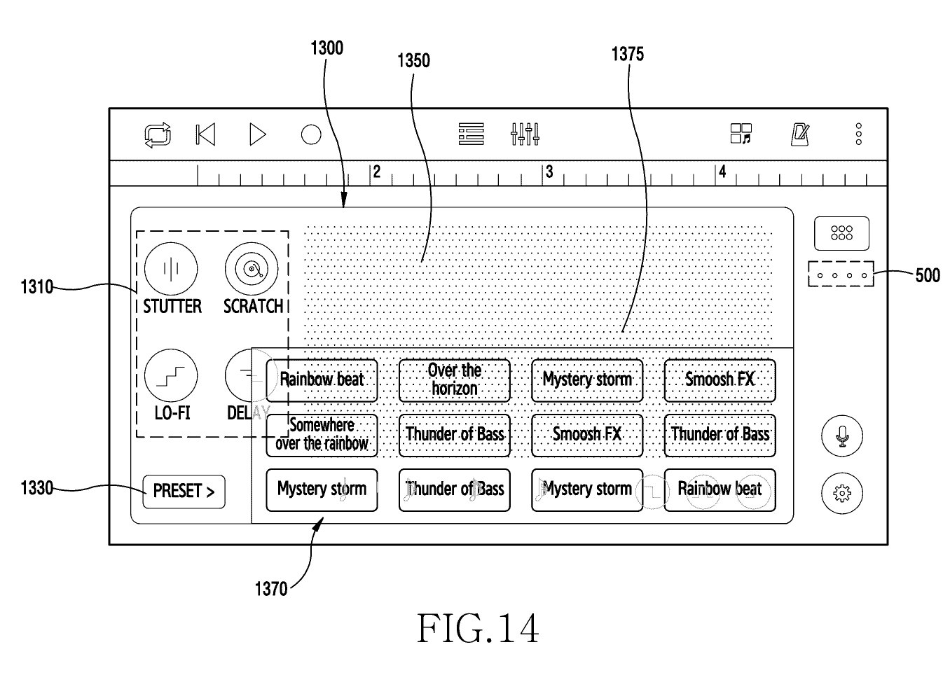

FIGS. 13 and 14 illustrate examples for describing synchronizing tempos of different elements in the electronic device according to embodiments of the present disclosure.

FIGS. 13 and 14 show examples of a user interface for setting an effect on music according to embodiments. For example, the controller 180 may switch the looper area to an effect setting window 1300 according to a user's control and display the effect setting window 1300, or display the effect setting window 1300 in the looper area. The effect setting window 1300 includes a plurality of type selection objects 1310 for setting an effect type, an effect selection object 1330 for selecting a preset effect, or an effect input pad 1350 (for example, chaos pad) for setting an effect by a user input based on the selected type.

The user may set an option (for example, parameter) for an audio effect through at least one of the type selection objects 1310. For example, the type selection objects 1310 generate various tones (or music patterns) for the effect and may set a sound quality (for example, lo-fi), scratch, delay, stutter, or frequency control (for example, sound dynamics).

The user selects an effect preset by the user through the effect selection object 1330 or preset on the electronic device. For example, when the effect selection object 1330 is selected by the user, the electronic device provides an effect selection window 1370 (for example, effect template) for selecting one of a plurality of preset effects as illustrated in the example of FIG. 14. That is, the effect selection object 1330 may be used for loading the effect selection window 1370, through which one of the pre-generated effects can be selected, in order to allow the user to conveniently and easily set a particular effect. The effect selection window 1370 may be provided in an overlaid form in the user interface or provided instead of one area of the user interface. The user selects a particular effect object in the effect selection window 1370, and the electronic device may set an effect in accordance with the selected effect object (for example, generate an effect based on an option corresponding to the effect object).

The user generates effect music (or event music) based on the option set as at least some of the aforementioned operations through the effect input pad 1350. For example, the effect input pad 1350 may be divided into a horizontal axis and a vertical axis and audio parameters may be allocated thereto. According to an embodiment, a length (for example, a playback time) of music (effect music) according to an effect may be set through the horizontal axis and a strength (for example, a sound strength or sound dynamics) of effect music may be set through the vertical axis. The user may input a user input (for example, a predetermined touch gesture having no particular pattern (for example, straight line)) into the effect input pad 1350, and the electronic device generates effect music having a length and a strength corresponding to the user input by tracking the user input. At this time, the effect music may have the length and the strength corresponding to the user input, and at least some effect of the aforementioned various options may be applied thereto. The electronic device outputs an object 1375 corresponding to a movement trace (or path) of the user input on the effect input pad 1350 in accordance with the user input into the effect input pad 1350.

Referring back to FIG. 12, the aforementioned effect setting operation may be performed in a state where at least one cell is selected in the looper area by the user and a sound sample of at least one selected cell is played (for example, audio output of the sound sample). When the sound sample is played (for example, audio output of the sound sample), tempo progress information of the played sound sample may be visually output or displayed. The electronic device may visually provide the tempo progress in time with the tempo of the played sound sample through the looper metronome 500. For example, a plurality of independent flickering objects (for example, points in the form of four lamps) of the looper metronome 500 may regularly flicker sequentially (for example, lamp flickering type).

The electronic device plays the sound sample in time with the tempo B according to a user's control and provide tempo progress information of the tempo B through the looper metronome 500. The electronic device detects a particular event related to playing of the effect music while the sound sample is played. The user may input a touch gesture for generating the effect music based on the aforementioned operation through the effect input pad 1350. The electronic device detects an event for playing a plurality of music (elements) of different attributes in response to the touch gesture on the effect input pad 1350 while the sound sample is played.

When the electronic device detects the event while playing the sound sample and providing the tempo progress information according to the tempo B of the sound sample using the looper metronome 500, the electronic device may start the effect music such that an event generating time point of the effect music according to the event matches the tempo B. For example, the electronic device performs synchronization such that the tempo A of the effect music according to the event matches the tempo B of the sound sample played before the generation of the event.

As described above, the electronic device performs the operation of synchronizing the tempo B of the played sound sample and the tempo A of the effect music according to the event. The electronic device processes the synchronization to play the project such that the tempo A of the effect music according to the event matches the beat of the tempo B of the played sound sample. For example, the electronic device may initiate the operation for playing the effect music according to the generation of the event in time with the looper metronome 500 displaying the tempo of the played sound sample. Accordingly, the electronic device may simultaneously provide the sound sample and the effect music without becoming off-beat. Here, the electronic device plays the effect music by a length of the effect music (or playback time or bit length). For example, the effect music may stop after being played for a defined bit length corresponding to a length of the progressed touch gesture on the horizontal axis of the effect input pad 1350 as described above.

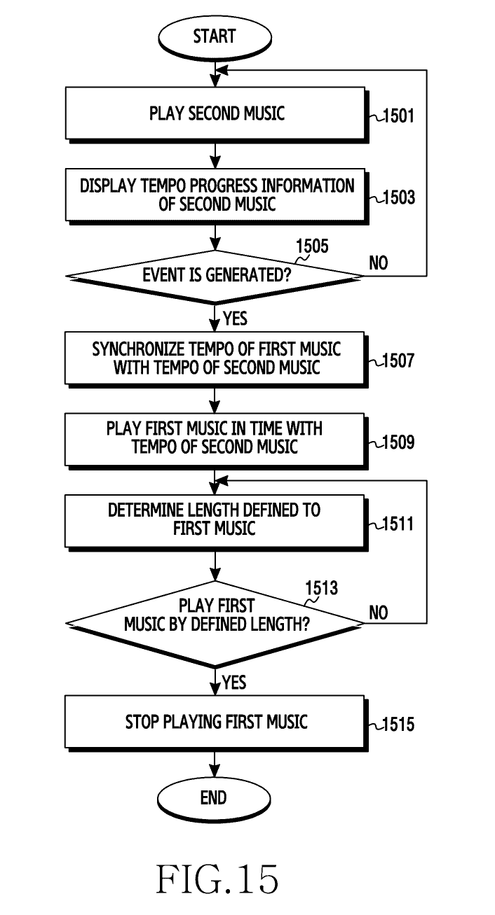

FIG. 15 illustrates a method of synchronizing tempos of different elements in the electronic device according to embodiments of the present disclosure.

Referring to FIG. 15, the controller 180 plays second music in step 1501, and display tempo progress information of the second music in response to the playing of the second music in step 1503. For example, the electronic device plays a sound sample (for example, process an audio output of the sound sample) in response to a user's control based on the aforementioned user interface and visually provide a tempo of the sound sample by the looper metronome 500 in response to the played sound sample.

In step 1505, the controller 180 determines whether an event is generated while processing the playing of the second music and the displaying of the tempo progress information of the second music. For example, the controller 180 detects an event (for example, a touch gesture input for setting an event using the effect input pad 1350) related to simultaneous playing of a first music with different attributes (for example, effect music) in addition to a second music.

When the event is not detected in step 1505 (1505: No), the controller 180 returns to step 1501.

When the event is detected in step 1505 (1505: Yes), the controller 180 performs synchronization such that the tempo of the first music according to the event matches the tempo of the played music in step 1507.

In step 1509, the controller 180 plays the first music according to the event in time with the tempo of the played second music.

The controller 180 determines a length defined to the first music in step 1511, and determines whether the first music is played by the defined length in step 1513. For example, the controller 180 determines the defined length (or playback time or bit length) of the effect music corresponding to the touch gesture on the effect input pad 1350 and play the effect music by the determined length.

When the first music is not played by the defined length in step 1513 (1513: No), the controller 180 returns to step 1511.

When the first music is played by the defined length in step 1513 (1513: Yes), the controller 180 may stop playing the first music in step 1515. Here, the controller 180 may stop playing the effect music after playing the effect music by the defined bit length corresponding to the length of the progressed touch gesture on the effect input pad 1350, and continuously maintain the playing of the second music (for example, sound sample) when stopping playing the first music.

An electronic device and an operation method thereof according to embodiments of the present disclosure synchronizes and provide a plurality of visual or acoustic outputs, which express tempos in a music application, without becoming off-beat with each other. According to the present disclosure, when the music application simultaneously provides playing of a plurality of elements having independent tempos and tempo progress information, it is possible to prevent the user from being confused about the beat. For example, according to embodiments of the present disclosure, when tempos of a plurality of elements are expressed, beats of the elements are synchronized and the elements are simultaneously output without becoming beat-off, so that user's visibility can be increased. Embodiments of the present disclosure provides an electronic device and an operation method thereof to meet needs of the user through the music application, thereby improving user convenience and contribute to improving usability, convenience, accessibility, and competitiveness of the electronic device.

The embodiments of the present disclosure disclosed herein and shown in the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a user interface;
a memory; and
one or more processors electrically connected to the user interface and the memory, wherein the one or more processors:
display tempo progress information of music in response to playing of the music,
detect an event while the music is being played,
synchronize the played music and tempo progress information of the music according to the event, and
output the synchronized music and tempo progress information.

2. The electronic device of claim 1, wherein the user interface includes a basic control area for a general control of a music application, a looper area including a plurality of cells on which various sound samples are set, and a looper control area for controlling the plurality of cells, and
wherein the basic control area and the looper control area include a metronome object that outputs a metronome function of each segments of played music.

3. The electronic device of claim 2, wherein the played music and the music according to the event correspond to segments of music which have different attributes and independently operate based on different layers.

4. The electronic device of claim 3, wherein the music includes first music in which a performance or an effect by at least one virtual musical instrument is configured as one package, and second music that repeats a melody or a beat in an identical music pattern.

5. The electronic device of claim 4, wherein the processor detects an event for the first music in the basic control area, outputs the tempo progress information corresponding to the first music through a metronome object of the basic control area, detects an event for the second music in the looper area, and outputs the tempo progress information corresponding to the second music through a metronome object of the looper control area.

6. The electronic device of claim 1, wherein the processor determines playing information related to the played music and the event music in response to the detection of the event while the music is played, and synchronizes a tempo of the played music and a tempo of the event music based on a result of the determination.

7. The electronic device of claim 6, wherein the processor plays first music, displays tempo progress information of the first music, synchronizes an event starting time point of a second music with a next beat of the first music when detecting an event related to simultaneous playing of the second music, and displays tempo progress information of the first music and the second music with the same tempo.

8. The electronic device of claim 7, wherein the processor starts the playing of the second music and the looper metronome in time with the next beat of the first music, and, in response to a control of the event starting time point of the second music, shifts a location of an indicator indicating a play progress state to a location corresponding to the controlled event starting time point and display the moved indicator.

9. The electronic device of claim 6, wherein the processor plays second music and displays tempo progress information of the second music, plays a first music in time with the tempo of the played a second music when detecting an event related to simultaneous playing of the first music, and displays the tempo progress information in accordance with independent tempos of the first music and the second music.

10. The electronic device of claim 9, wherein the processor stops playing the first music after playing the first music by a bit length defined to the first music, and continuously maintains the playing of the second music after stopping playing of the first music.

11. The electronic device of claim 1, wherein the memory stores instructions to instruct the one or more processors to display the tempo progress information of the music in response to the playing of the music, to detect the event while the music is played, and to synchronize and output the played music and the tempo progress information of the music according to the event when the instructions are executed.

12. A method of operating an electronic device, the method comprising:
playing music and displaying tempo progress information of the music based on a user interface;
detecting an event while the music is played; and
synchronizing the played music and tempo progress information of the music according to the event and outputting the synchronized music and tempo progress information.

13. The method of claim 12, wherein the user interface includes a basic control area for a general control of a music application, a looper area including a plurality of cells on which various sound samples are set, and a looper control area for controlling the plurality of cells, and the basic control area and the looper control area include a metronome object that outputs a metronome function of each segments of played music.

14. The method of claim 13, wherein the played music and the music according to the event correspond to segments of music which have different attributes and independently operate based on different layers, and the music includes a first music in which a performance or an effect by at least one virtual musical instrument is configured as one package, and a second music that repeats a melody or a beat in an identical music pattern.

15. The method of claim 14, further comprising:
detecting an event for the first music in the basic control area and outputting the tempo progress information corresponding to the first music through a metronome object of the basic control area; and
detecting an event for the second music in the looper area and outputting the tempo progress information corresponding to the second music through a metronome object of the looper control area.

16. The method of claim 12, wherein synchronizing the played music and tempo progress information comprises determining playing information related to the played music and the event music in response to the detection of the event while the music is played and synchronizing a tempo of the played music and a tempo of the event music based on a result of the determination.

17. The method of claim 16, wherein synchronizing the played music and tempo progress information comprises:
playing first music and displaying tempo progress information of the first music;
synchronizing an event starting time point of second music with a next beat of the first music when detecting an event related to simultaneous playing of the second music; and
displaying tempo progress information of the first music and the second music with the same tempo.

18. The method of claim 17, wherein synchronizing the played music and tempo progress information comprises:
starting the playing of the second music and the looper metronome in time with the next beat of the first music; and
in response to a control of the event starting time point of the second music, shifting a location of an indicator indicating a play progress state to a location corresponding to the controlled event starting time point and displaying the moved indicator.

19. The method of claim 16, wherein synchronizing the played music and tempo progress information comprises:
playing second music and displaying tempo progress information of the second music;
playing first music in time with the tempo of the played second music when detecting an event related to simultaneous playing of the first music; and
displaying the tempo progress information in accordance with independent tempos of the first music and the second music.

20. The method of claim 19, further comprising stopping playing of the first music after playing the first music by a bit length defined to the first music, and continuously maintaining the playing of the second music after stopping playing the first music.
